(19) United States
(12) Patent Application Publication
(10) Pub. No.: US 2002/0083189 A1
(43) Pub. Date: Jun. 27, 2002

(54) Relay of a datagram

(76) Inventor: Patrick L. Connor, Portland, OR (US)

Correspondence Address: FISH & RICHARDSON P.C., Suite 500, 4350 La Jolla Village Drive, San Diego, CA, 92122, US

(21) Appl. No.: 09/749,215

(22) Filed: Dec. 27, 2000

(51) Int. Cl. G06F 15/16

(52) U.S. Cl. 709/236; 709/230

(57) ABSTRACT

The length of the data being received from a sending network is determined, a relay threshold is determined, and relay of the data to a receiving network is initiated when a received portion of the data exceeds the relay threshold.

This invention relates to relay of data.

### BACKGROUND

In a computer connected to an Ethernet, a media-access-controller is typically placed between the Ethernet and the PCI bus that interconnects the components of the host. The controller includes a FIFO (first-in-first-out) memory for buffering incoming and outgoing data. Using the FIFO-memory, the controller can regulate the flow of data between the network of devices internal to the computer (which we will call the host) and the Ethernet network external to the host. Data flows in the form of data packets, or datagrams that include a payload section containing the data of interest and a header section containing information about the payload section.

Many media-access-controllers regulate data flow by implementing cut-through ingress and egress algorithms. In a cut-through ingress, the controller begins the process of transferring data from its FIFO-memory to the host's memory as soon as a threshold number of bytes from a datagram have arrived from the Ethernet. In a cut-through egress, the media-access-controller begins transferring data from its FIFO-memory to the Ethernet when a threshold number of bytes of a datagram have arrived from the host. Both cut-through algorithms provide common advantages: the data reaches its destination sooner, and less FIFO-memory is required.

A device that wants to use the PCI bus to transmit data often has to wait its turn while other devices connected to the bus communicate with each other. Because of this overhead associated with each transaction on the PCI bus, it is preferable to complete data transmission in one bus transaction. For both cut-through ingress and egress algorithms, the threshold number of bytes (“relay threshold”) must be correctly determined so that the transmission of an entire datagram can be completed within one bus transaction and without unnecessary latency.

The receiving network can drain data from the FIFO-memory faster than the source network can fill it. To enable the transfer of a datagram in one continuous transaction, the source network is given enough of a head start so that the receiving network cannot completely drain the FIFO memory until the end of the datagram has been reached. However, the head start is not so large as to introduce unnecessary latency. The effectiveness of any cut-through algorithm depends largely on correctly choosing the extent of this head start or equivalently, correctly choosing the relay threshold.

The relay threshold is determined on the basis of statistics maintained by the device driver or controller. Because data traffic includes datagrams of different sizes, this statistical method of determining relay threshold is often not optimized for the size of the datagram currently being relayed. For example, if a small datagram were to arrive in the middle of a long run of large datagrams, the relay threshold may be set so high that the small datagram is completely buffered in the FIFO-memory before data transfer begins. In this case, the small datagram would not benefit from the cut-through algorithm. Conversely, if a large datagram were to arrive in the middle of a long run of small datagrams, the relay threshold may be set so low that data transfer begins before enough of the large datagram has arrived in the FIFO-memory. In such a case, the FIFO-memory may run out of data while the media-access-controller still has access to the PCI bus.

Typical cut-through approaches tend to be biased toward larger datagrams, because the controller cannot detect that the relay threshold is too high. It can only detect when the relay threshold is too low. As a result, a long run of large datagrams drives the relay threshold upwards, whereas a correspondingly long run of small datagrams tends not to drive the relay threshold back downward.

### BRIEF DESCRIPTION OF THE FIGURES

FIG. 1 shows a host computer connected to a network;

FIGS. 2, 3 and 6 are flowcharts for relaying data between the network and the host's memory;

FIG. 4 shows timing diagrams that illustrate the relay of data from the sending network to the receiving network; and

FIG. 5 is a table corresponding to FIG. 4.

### DESCRIPTION

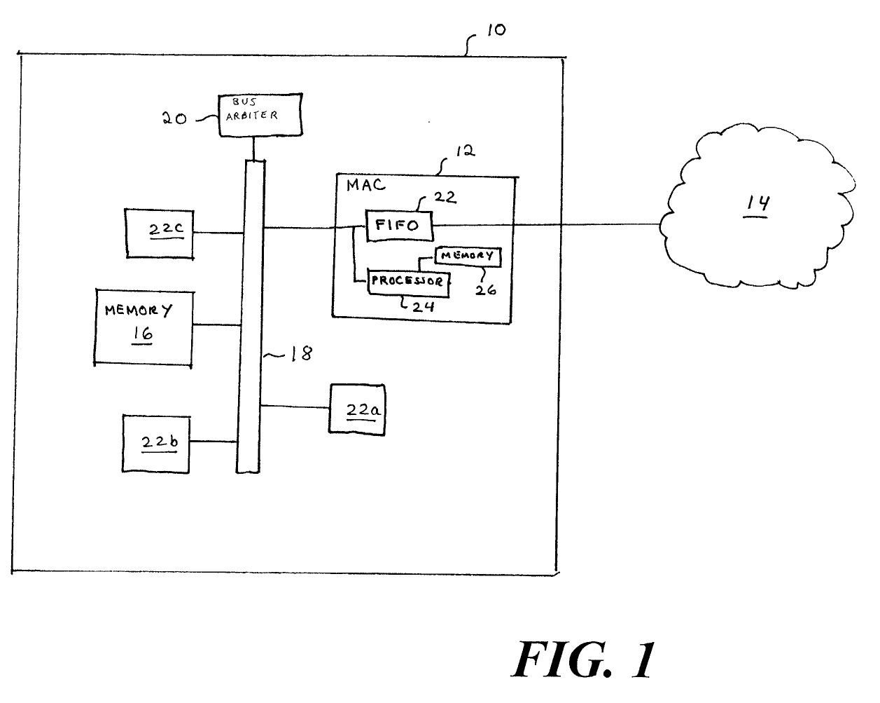

FIG. 1 shows a host computer system 10 in which a media-access-controller 12 regulates the flow of data between a network 14 and a host memory 16. The controller 12 and the host memory 16 are connected to a bus 18 that is under control of a bus-arbiter 20. In many host computer systems, the bus-arbiter 20 implements a PCI (Peripheral Component Interface) protocol or a PCI-X (Peripheral Component Interface extended) protocol, but other bus protocols could be used. Both PCI and PCI-X are well-known local bus standards developed by PCI SIG member companies. The bus-arbiter 20 allocates use of the bus 18 so that the memory 16, the controller 12, and the various other devices 22a-c that form part of the host computer system 10 take turns using the bus 18 to communicate with each other.

A typical bus 18 includes several parallel wires that together constitute the data lines. At each clock interval, each parallel wire holds one bit to be transmitted during that clock interval. The product of the number of data lines, referred to as the bus width, and the clock rate is thus a measure of how fast the bus 18 can transmit data. For a typical PCI bus, the bus width is either 32 or 64 bits and the clock rate is either 33 MHz or 66 MHz. Thus, the maximum burst rate at which a PCI bus transmits data ranges from 1067 megabits per second to 4267 megabits per second. A 64-bit PCI-X bus with a 133 MHZ clock, transmits data at a maximum of approximately 8533 megabits per second.

The burst rate at which the network 14 can transmit data to the host 10 depends on the link used to connect the host to the network 14. For a 10-Base-T transmission line conforming to the IEEE 802.3 standard for local area networks, the burst rate is on the order of 10 megabits per second, which is much slower than even the slowest PCI bus. However, a 10 gigabit Ethernet line conforming to the IEEE 802.3ae standard has a burst rate of 10,000 megabits per second, which is higher than even the fastest PCI-X bus.

The controller 12 includes a FIFO-memory 22 connected to the bus 18 and to the network 14. The flow of data into or out of the FIFO-memory 22 is controlled by a local processor 24 in communication with a local memory 26.

The controller 12 delays the start of the data transfer until enough of an incoming message, or datagram, has arrived in the FIFO-memory 22 to enable completion of the transfer from the sending network to the receiving network in one transaction. The number of bytes of the datagram that must be in the FIFO-memory 22 upon initiation of the data transfer is referred to as the optimal relay-threshold for the datagram. The value of this optimal relay-threshold depends on the relative data transmission speeds of the sending and receiving networks and on the length of the datagram. For example, if the receiving network were twice as fast as the sending network, the controller 12 would start sending data to the receiving network upon receiving half of the datagram in the FIFO-memory 22.

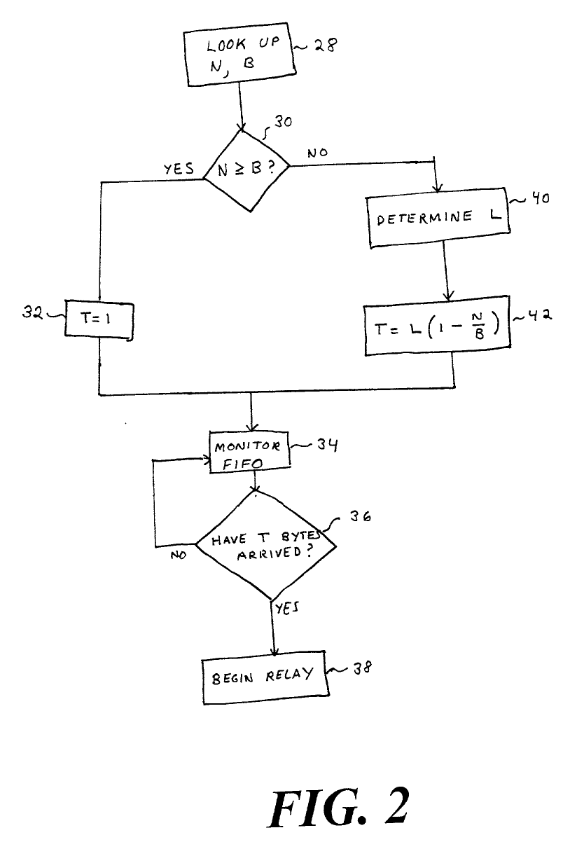

In operation, as shown in FIG. 2, the local processor 24 first looks up 28 the maximum burst rate, N, of the sending network and the maximum burst rate B of the receiving network. These two burst rates are obtained by the local processor 24 when it is first installed and configured for the host computer system 10. In the example of FIG. 2, the sending network is assumed to be the Ethernet and the receiving network is assumed to be the collection of devices served by the bus 18 in the host computer system 10.

The local processor 24 then determines 30 whether the sending network is faster than the receiving network. If this is the case, then there is no need to delay relay of a datagram. Hence, delayed relay is effectively disabled 32 by setting the threshold, T, to be as low as possible. The local processor 24 then waits 34 and periodically checks to see if T bytes of the datagram have arrived 36. If so, the controller 12 initiates 38 the relay of the datagram to the receiving network. Otherwise, the controller 12 continues to wait 34.

If the local processor 24 determines 30 that the receiving network is faster than the sending network, it next determines 40 the length of the datagram. In an ingress operation, the local processor 24 determines the length of the datagram by first parsing the datagram's header. In the case of a SNAP type header, the type-length field of the header contains information representative of the length of the datagram. For other types of Ethernet headers, the datagram's length can be obtained from a layer 3 header, for example the length field of an IP (internet protocol) header. Because the header of a datagram arrives before its payload, the local processor 24 can often determine 40 the datagram's length before the entire datagram has arrived. In an egress operation, the local processor 24 determines the length of the datagram using control information from the device driver used to initiate the egress operation.

The PCI-X protocol requires that at the time the request for bus access is made, the sender provide the total number of bytes to be transferred on the bus 18. In conventional cut-through ingress, the sender generally does not know the datagram's length until after the request for bus access has been made and the relay of data has been completed. In the invention, the datagram's length is determined shortly after the header arrives from the sending network. As a result, a host computer system that has a PCI-X bus can use the method to enjoy the benefits of cut-through ingress. Additionally, the PCI-X protocol guarantees that, within certain limits, bursts will not be interrupted. This allows for better calculation of thresholds for cut-through egress.

The local processor 24 next uses the datagram's length to determine 42 the optimal relay-threshold. The optimal relay-threshold for a datagram depends on its length and on the relative burst rates of the sending and receiving networks (Ethernet and the PCI bus 18). In particular, the optimal relay-threshold is given by the product of the datagram's length and the extent to which the ratio of the sending burst rate to the receiving burst rate is less than one.

In the case of a cut-through egress operation in which the sending network is a PCI bus 18, the determination of the optimal relay-threshold depends in part on the availability of the PCI bus 18. This is because in a PCI bus, once a transfer to FIFO-memory 22 begins, there is no guarantee that transfer will complete without interruption. As a result, the actual transfer rate of a datagram depends on how busy the PCI bus 18 is. If the PCI bus 18 is rarely used, the effective transfer rate of the datagram will be approximately equal to the maximum burst rate. However, if there are many devices that compete for bus access, the effective transfer rate of the datagram will be reduced to the extent that interruptions occur during transmission of the datagram.

Because of the inherent unpredictability of data transfer on a PCI bus 18, it is useful for the local controller 24 to determine an effective transfer rate. This effective transfer rate reflects the likelihood that a transfer will be interrupted. As the number of devices sharing the bus increases, the probability of an interruption during a particular transmission interval increases. As the length of the datagram increases, the time required to transfer the datagram also increases. Hence, the probability of an interruption during the transfer of that datagram also increases. The effective transfer rate can thus depend on, among other factors, the number of devices sharing the PCI bus and the length of the datagram.

In one aspect of the invention, the local controller 24 maintains or has access to statistics on usage of the sending and/or receiving networks. These statistics can be used by the local controller 24 to determine an effective transfer rate and to update the effective transfer rate as usage of those networks changes with time.

In either case, the optimal relay-threshold can be adjusted to reflect the extent to which the receiving network will tolerate running out of data in FIFO-memory 22 (referred to as an “under-run”) during the relay operation. If the receiving network is relatively intolerant of under-runs, the optimal relay-threshold can be adjusted upward to reduce the probability of an under-run. If the receiving network is tolerant of under-runs, the optimal relay-threshold can be used to minimize latency associated with data relay.

Each bus-master on the PCI bus 18 has a guaranteed minimum transfer time during which it can access the bus without interruption. If the transfer of the datagram to the FIFO-memory 22 can be completed before the expiration of this guaranteed minimum transfer time, then the local processor 24 can determine the optimal relay-threshold using the maximum burst rate as the effective transfer rate of the datagram to the FIFO-memory 22. If the transfer of the datagram to the FIFO memory 22 cannot be completed before the guaranteed minimum transfer time, then the local processor 24 can instead determine the optimal relay-threshold using an effective transfer rate as described above.

A PCI-X bus provides an additional restriction on when a data transfer can be interrupted. In a PCI-X bus, a data transfer can only be interrupted at an “address disconnect boundary”. The data between two address disconnect boundaries is referred to as an “address disconnect boundary quantum” (ADQ).

Once the transfer of the last ADQ has begun, the remaining data to be transferred is guaranteed to be transferred without interruption. With this transfer guarantee, the local processor 24 can again use the maximum burst rate as the effective transfer rate of the datagram to the FIFO-memory 22.

To ensure that under-runs do not occur, the local processor 24 begins the data relay after the transfer is guaranteed to complete on the PCI or PCI-X bus. This may require that the local processor 24 delay the beginning of the data relay until after the optimal relay-threshold has been reached in the FIFO-memory 22. If the receiving network can tolerate occasional under-runs, then the local processor 24 begins the data relay as soon as, or shortly after the optimal relay-threshold has been reached in the FIFO-memory 22, even if this occurs before the transfer is guaranteed to complete.

Following determination of the optimal relay-threshold, the local processor 24 waits 34 and periodically checks to see if T bytes of the datagram have arrived 36 at the FIFO-memory 22. If so, the local processor 24 initiates 38 the relay of the datagram to the receiving network. Otherwise, the local processor 24 continues to wait 34.

If the sending network transmits serially and the receiving network receives in parallel, it is more efficient to delay relaying the datagram until enough serial data has arrived to fill all the parallel lines. For example, when the receiving network is served by a 64-bit wide PCI bus 18 receiving data from a serial Ethernet link, the local processor 24 waits until 64 data bits have accumulated in the FIFO-memory 22 before starting data transfer on the PCI bus 18. The local processor 24 then sets the optimal relay-threshold to be a multiple of the bus width.

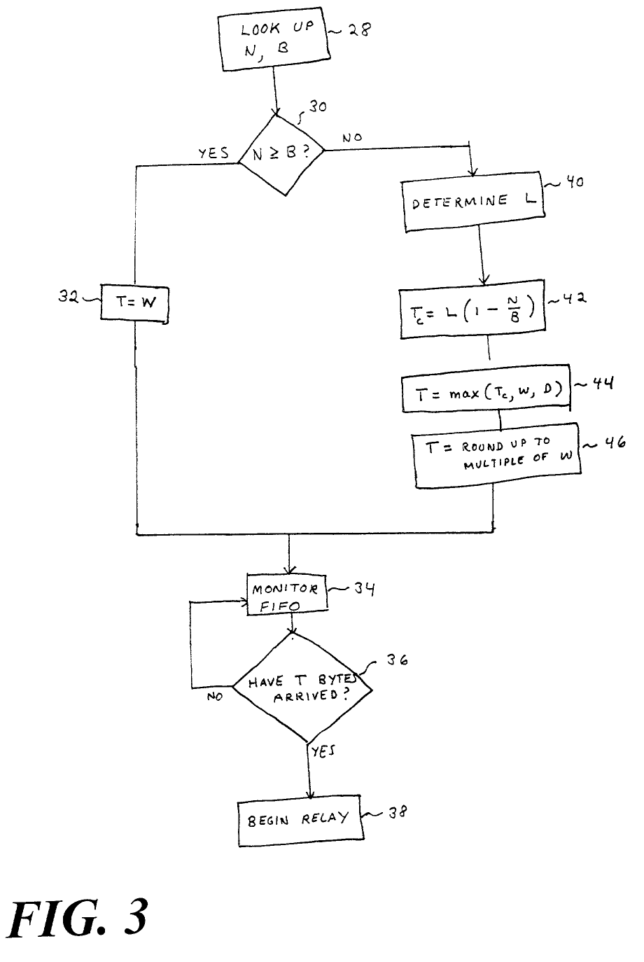

FIG. 3 shows an alternative implementation of the data relay method that takes constraints such as these into account. The local processor 24 first looks up 28 the maximum burst rate, N, of the sending network and the maximum burst rate, B, of the receiving network. These two burst rates are obtained by the local processor 24 when the controller 12 is first installed and configured for the host computer system 10. In the example of FIG. 3, the sending network is assumed to communicate with the controller 12 via a serial data link, such as the Ethernet, and the receiving network is assumed to communicate with the controller 12 via a parallel data link W bytes wide.

The local processor 24 then determines 30 whether the sending network is faster than the receiving network. If so, there is no need to delay relay of the datagram. Hence, delayed relay is effectively disabled 32 by setting the threshold, T, to be equal to the width W of the parallel data link. The local processor 24 then waits 34 and periodically checks to see if T bytes of the datagram have arrived 36. If so, the local processor 24 initiates 38 the relay of the datagram to the receiving network. Otherwise, the local processor 24 continues to wait 34.

If the local processor 24 determines 30 that the receiving network is faster than the sending network, it next determines 40 the length of the datagram as in FIG. 2. The local processor 24 then uses the datagram's length to determine 42 a calculated relay threshold, Tc, as in the calculation of the optimal relay-threshold, T, in FIG. 2.

In the method shown in FIG. 3, the calculated relay threshold Tc need not be the optimal relay-threshold, T. It is, instead, only one of three candidates for the optimal relay-threshold, T. The other two candidates are the number of bytes, D, that must arrive at the controller 12 before the controller 12 can determine the length L of the datagram, and the width of the parallel link, W. The local processor 24 sets 44 the optimal relay-threshold T to be the largest of these three candidates. Then, because it is more efficient to begin data transfer with all lines in the parallel link in use, the optimal relay-threshold thus determined is rounded up 46 to the nearest multiple of the parallel data-link width, W.

The optimal relay-threshold is the number of bytes that should be present in the FIFO-memory 22 before the controller 12 begins bursting data onto the receiving bus 18. In many cases, before data can be placed on the bus 18, certain steps must be taken before the bus 18 is ready to receive data from the controller 12. For example, access to the bus 18 must be requested and granted. Arbitration and addressing may need to be completed. These initial steps, the multiple occurrences of which is avoided by correctly selecting the optimal relay-threshold, can be performed before the correct number of bytes has arrived in the FIFO-memory 22. This increases the likelihood that the bus 18 will be ready for receiving data from the controller 12 as soon as the correct number of bytes has arrived in the FIFO-memory 22.

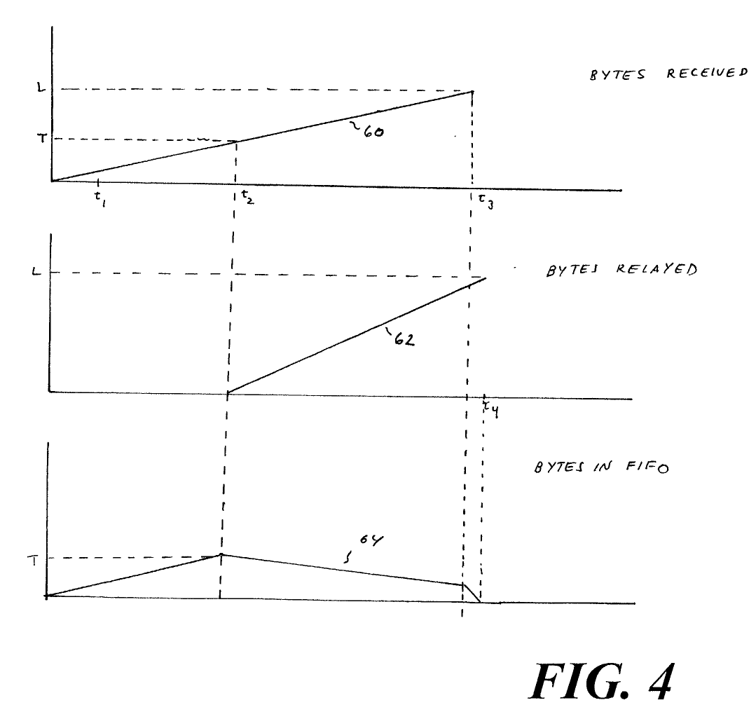

In FIG. 4, the line 60 in the upper graph shows the number of bytes accumulated by the FIFO-memory 22 from the sending network. The slope of this line 60 is therefore the burst rate of the sending network, S. The line 62 in the middle graph shows the number of bytes relayed from the FIFO-memory 22 to the receiving network. The slope of this line 62 is therefore the burst rate of the receiving network, B. The line 64 on the third graph shows how many bytes from the datagram are in the FIFO-memory 22 at various times during the relay operation.

The value of the optimal relay-threshold T is determined once the header of the datagram has arrived in the FIFO-memory 22. A header-delivery interval, during which the header is being delivered, is shown in the upper graph between t=0 and t=t1. During this header-delivery interval, the local processor 24 does not yet know the optimal relay-threshold because it does not yet know the length of the incoming datagram.

During a payload-receiving interval between t=t1 and t=t3, the sending network completes transmission of the datagram to the FIFO-memory 22. This payload-receiving interval is divided into a pre-threshold interval, between t1 and t2, and a post-threshold interval, between t2 and t3. During the pre-threshold interval, the number of bytes received by the FIFO-memory 22 is below the optimal relay-threshold T. Hence, no bytes are relayed to the receiving network, as shown in the middle graph. During the pre-threshold interval, the lower graph matches the upper graph.

Once the number of bytes accumulated in the FIFO-memory 22 reaches the optimal relay-threshold T, the local processor 24 begins relaying data to the receiving network, as shown in the middle graph. This starts a relay interval that lasts from the beginning of the post-threshold interval at t2 until all data has been relayed out of the FIFO-memory 22 at t4. Between the beginning of the relay interval and the end of the post-threshold interval, the FIFO-memory 22 continues to slowly receive data from the sending network even while it rapidly relays data to the receiving network. The net result, shown in the lower graph, is a slow draining of the FIFO-memory 22. Between the end of the post-threshold interval, t3, and the end of the relay interval, t4, the FIFO-memory 22 drains more rapidly because no additional data is being received from the sending network.

The optimal relay-threshold T, and hence the beginning of the relay interval at t=t2, is selected to minimize the gap between the end of the post-threshold interval at t3 and the end of the relay interval at t4. However, the optimal relay-threshold T must also be large enough so that at no time during the relay interval does the FIFO-memory 22 ever run out of data to relay to the receiving network.

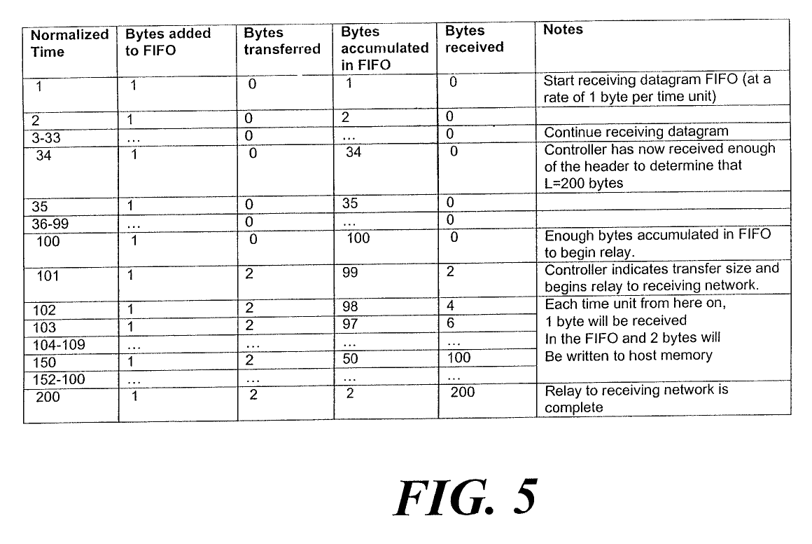

FIG. 5 shows a detailed example in which a 200 bytes datagram is delivered from a sending network to a receiving network that accepts data twice as fast as the sending network can deliver it. In this example, the header-delivery interval lasts from t=1 to t=35. By the end of the header-delivery interval, the local processor 24 will have learned that the datagram is 200 bytes long and that the optimal relay-threshold should therefore be set at 100 bytes.

During the pre-threshold interval, which lasts from t=36 to t=100, the FIFO-memory 22 continues to accumulate data. Once 100 bytes have been accumulated in the FIFO-memory 22, the local processor 24 begins relaying data to the receiving network. This begins the relay interval, which lasts until t=200. At the end of the relay interval, the entire datagram will have been relayed to the receiving network.

The optimal relay-threshold need not be calculated as shown in FIGS. 2 and 3, but can instead be obtained from a look-up table. Since the number of possible datagram lengths is large, the look-up table can divide the range of datagram lengths into several smaller ranges and provide a separate optimal relay-threshold for each one of those smaller ranges. These separate optimal relay-thresholds can be dynamically adjusted on the basis of statistics maintained by the local processor 24. Thus, when a small datagram arrives, the local processor 24 uses the length of the small datagram to adjust the relay threshold for small datagrams without affecting the relay thresholds for large or mid-length datagrams. This reduces the likelihood that the single relay threshold will converge to a value that optimizes relay of larger datagrams at the expense of smaller datagrams.

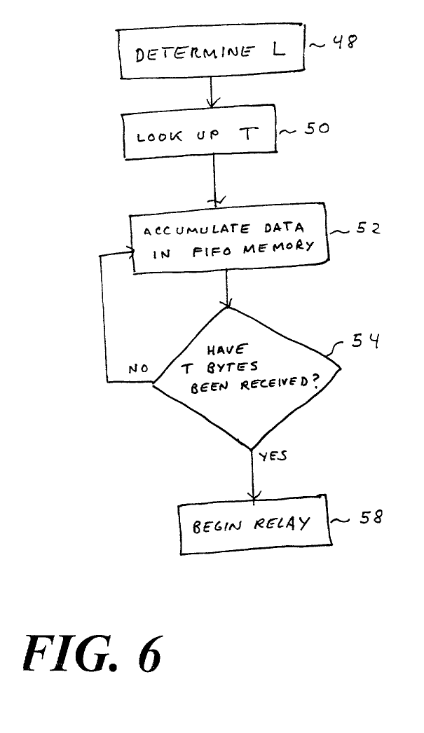

FIG. 6 shows a relay method that uses a look-up table, as described above. The method begins with the local processor 24 determining 48 the length of the datagram that is to be relayed from the sending network to the receiving network. The local processor 24 then looks up 50 an optimal relay-threshold value for that datagram length and begins accumulating 52 the datagram in FIFO-memory 22. Note that for egress operations this method also differs from that described in connection with FIGS. 2 and 3 because the datagram's length is already known at the time that the FIFO-memory 22 begins to accumulate 52 the bytes that make up the datagram.

Once the FIFO-memory 22 begins to accumulate the bytes making up the datagram, the processor monitors 54 the FIFO-memory 22 to see if the number of bytes accumulated has reached the optimal relay-threshold. If it has, the local processor 24 begins relaying 58 the frame to the receiving network. Otherwise, the local processor continues to monitor 54 the FIFO-memory 22.

Other embodiments are within the scope of the following claims:

1. A method comprising:
determining a length of a message received from a sending network; and
initiating relay of said message to a receiving network when a received portion of said message exceeds a relay threshold.

2. The method of claim 1 further comprising determining said relay threshold on the basis of said length.

3. The method of claim 1 wherein determining a length of said message comprises:
determining a length of said message on the basis of information contained in a header of said message.

4. The method of claim 1 wherein determining a length of said message comprises:
determining a length of said message on the basis of information obtained as part of a transmission protocol.

5. The method of claim 1 further comprising selecting said receiving network to be a network served by a bus.

6. The method of claim 1 further comprising selecting said sending network to be a packet-switched network.

7. The method of claim 1 further comprising selecting said sending network to be a network served by a bus.

8. The method of claim 1 further comprising selecting said receiving network to be a packet-switched network.

9. The method of claim 1 further comprising determining said relay threshold based on
a data transmission rate associated with said sending network, and
a data receiving rate associated with said receiving network.

10. The method of claim 9 wherein determining a data transmission rate associated with said sending network comprises:
determining a likelihood with which receipt of said message from said sending network will be interrupted; and
determining an effective data transmission rate on the basis of said likelihood.

11. The method of claim 10 wherein determining said likelihood comprises analyzing statistics on usage of said sending network and/or said receiving network.

12. The method of claim 9 wherein determining said relay threshold further comprises
evaluating a quantity derived from said data transmission rate and said data receiving rate, and
weighting said quantity by said length of said message.

13. The method of claim 1 wherein said receiving network includes a bus having a bus width and determining said relay threshold comprises constraining said relay threshold to be a multiple of said bus width.

14. The method of claim 1 wherein determining said relay threshold comprises obtaining said relay threshold from a look-up table.

15. A controller for relaying a message from a sending network to a receiving network, said controller comprising:
a first memory element in communication with said sending network and said receiving network; and
a processor for monitoring content of said first memory element, said processor initiating relay of said message to said receiving network when a received portion of said message in said first memory element exceeds a relay threshold.

16. The controller of claim 15 further comprising a relay-threshold determining process for determining a relay-threshold on the basis of a length of said message.

17. The controller of claim 15 further comprising a message parser, said message parser being adapted for extracting, from said message, information indicative of said length of said message.

18. The controller of claim 15 wherein said first memory element is in communication with a receiving network served by a bus and said first memory element is in communication with a packet-switched sending network.

19. The controller of claim 15 wherein said first memory element is in communication with a sending network served by a bus and said first memory element is in communication with a packet-switched receiving network.

20. The controller of claim 15 further comprising a second memory element for storage of a data transmission rate associated with said sending network, and a data receiving rate associated with said receiving network, said second memory element being in communication with said relay threshold determining process

21. The controller of claim 20 wherein said relay-threshold determining process comprises:
a network-speed-adjustment process in communication with said second memory element for evaluating a quantity representative of an extent to which said data receiving rate differs from said data transmission rate; and
a weighting process in communication with said network-speed-adjustment process for weighting said quantity representative of said extent to which said data receiving rate differs from said data transmission rate by said length of said message.

22. The controller of claim 16 wherein said relay-threshold determining process comprises a look-up table for providing a relay threshold on the basis of a message length.

23. A system comprising:
a controller having a first port and a second port, said controller being adapted for determining a relay threshold on the basis of a length of a message received at said first port and relaying said message through said second port when a buffered portion of said message has a length exceeding said relay threshold.
a bus in communication with one of said first port and said second port; and
a host memory element in communication with said bus.

24. A machine-readable medium having encoded thereon software for relaying a message from a sending network to a receiving network, said software comprising instructions for:
determining a length of said message; and
initiating relay of said message when a received portion of said message exceeds said relay threshold.

25. The machine-readable medium of claim 24 wherein said software further comprises instructions for determining a relay threshold of said message on the basis of said length.

26. The machine-readable medium of claim 24 wherein said instructions for determining a length of said message comprise instructions for determining a length of said message on the basis of information contained in a header of said message.

27. The machine-readable medium of claim 24 wherein said instructions for determining a length of said message comprise instructions for determining a length of said message on the basis of information provided by a protocol associated with transmission of said message.

28. The machine-readable medium of claim 24 wherein said instructions for initiating relay of said message comprise instructions for passing said message to a network served by a bus.

29. The machine-readable medium of claim 24 wherein said instructions for initiating relay of said message comprise instructions for passing said message to a packet-switched network.

30. The machine-readable medium of claim 24 wherein said instructions for determining said relay threshold comprise instructions for evaluating a quantity derived from
a data transmission rate associated with said sending network, and
a data receiving rate associated with said receiving network.

31. The machine-readable medium of claim 30 wherein said instructions for determining a data transmission rate associated with said sending network comprise instructions for:
determining a likelihood with which receipt of said message from said sending network will be interrupted; and
determining an effective data transmission rate on the basis of said likelihood.

32. The machine-readable medium of claim 31 wherein said instructions for determining said likelihood comprise instructions for analyzing statistics on usage of said sending network and/or said receiving network.

33. The machine-readable medium of claim 30 wherein said instructions for determining said relay threshold further comprise instructions for weighting, by said length of said message, said quantity derived from said first transmission rate and said second transmission rate.

34. The machine-readable medium of claim 24 wherein said instructions for determining said relay threshold comprise instructions for constraining said relay threshold to be a multiple of a bus width associated with a bus serving said receiving network.

35. The machine-readable medium of claim 24 wherein said instructions for determining said relay threshold comprise instructions for obtaining said relay threshold from a look-up table.
